(19) United States
(12) Patent Application Publication
(10) Pub. No.: US 2016/0080469 A1
(43) Pub. Date: Mar. 17, 2016

(54) DATA COMMUNICATION METHOD AND DATA COMMUNICATION SYSTEM

(71) Applicant: Huizhou Kimree Technology Co., Ltd., Huizhou (CN)

(72) Inventor: Qiuming LIU, Huizhou (CN)

(21) Appl. No.: 14/736,924

(22) Filed: Jun. 11, 2015

Related U.S. Application Data
(63) Continuation of application No. PCT/CN2014/086493, filed on Sep. 15, 2014.

(51) Int. Cl. H04L 29/08; H04W 12/06; H04L 29/06

(52) U.S. Cl. CPC H04L 67/06; H04L 67/306; H04L 63/08; H04W 12/06; H04W 92/08

(57) ABSTRACT

A data communication method and a data communication system are provided. The method includes: transmitting, by an electronic cigarette, collected smoking-related data to a mobile terminal bound with the electronic cigarette; transmitting, by the mobile terminal, the smoking-related data to a service platform; determining, by the service platform, a user level corresponding to the smoking-related data; determining, by the service platform, information corresponding to the user level; and pushing, by the service platform, the information corresponding to the user level to the mobile terminal. The service platform pushes the information corresponding to the smoking-related data to the mobile terminal, and the mobile terminal receives the information, such that the service platform provides a customized information pushing service to the user. Different services may be pushed according to different user levels, and merchants may provide customized services and improve service quality, thereby improving user experience.

This application is a continuation application of International Application No. PCT/CN2014/086493, entitled “DATA COMMUNICATION METHOD AND DATA COMMUNICATION SYSTEM” and filed on Sep. 15, 2014, which is hereby incorporated by reference in its entirety.

### FIELD

The disclosure relates to the communication field, and in particular, to a data communication method and a data communication system.

### BACKGROUND

The electronic cigarette is a new electronic product, having similar appearance and similar flavor to a tobacco cigarette. Compared with the tobacco cigarette, the electronic cigarette is healthier and more environmentally friendly.

Due to lack of understanding of information related to the electronic cigarettes, many clients of the electronic cigarettes may not acquire more information related to the electronic cigarettes to acquire better experience in using the electronic cigarettes.

In conventional technology, since understanding of a user on the information related to the electronic cigarette is unacquirable, information satisfying user requirement can not be provided to the user based on specific situation of the user. Furthermore, customized services can not be provided to the user of the electronic cigarette, and accordingly, user experience can not be improved.

### SUMMARY

A data communication method and a data communication system are provided in the disclosure, with which customized services may be pushed to a user of an electronic cigarette, thereby improving user experience.

The data communication method includes:

transmitting, by an electronic cigarette, collected smoking-related data to a mobile terminal bound with the electronic cigarette;

transmitting, by the mobile terminal, the smoking-related data to a service platform;

determining, by the service platform, a user level corresponding to the smoking-related data;

determining, by the service platform, information corresponding to the user level; and

pushing, by the service platform, the information corresponding to the user level to the mobile terminal.

In the data communication method, before the determining, by the service platform, a user level corresponding to the smoking-related data, the data communication method further includes:

receiving, by the mobile terminal, object login information input by a user;

transmitting, by the mobile terminal, the object login information to the service platform;

determining, by the service platform, whether the mobile terminal is a registered user based on the object login information; and

triggering, by the service platform, the step of determining, by the service platform, the user level corresponding to the smoking-related data, if the mobile terminal is the registered user.

In the data communication method, before the receiving, by the mobile terminal, object login information input by a user, the method data communication further includes:

receiving, by the mobile terminal, login information input by the user, where the login information includes a username and a password;

transmitting, by the mobile terminal, the login information to the service platform;

determining, by the service platform, whether the username included in the login information is the same as a username stored in the service platform;

determining, by the service platform, that the mobile terminal is successfully registered if the username included in the login information is not the same as the username stored in the service platform; and

storing, by the service platform, the login information into a database.

The determining, by the service platform, whether the mobile terminal is a registered user based on the object login information includes:

determining, by the service platform, whether the object login information is the same as the login information stored in the database; and

determining, by the service platform, that the mobile terminal transmitting the object login information is the registered user if the object login information is the same as the login information stored in the database.

In the data communication method, before the determining, by the service platform, a user level corresponding to the smoking-related data, the data communication method further includes:

acquiring, by the mobile terminal, a hardware identifier of the mobile terminal;

transmitting, by the mobile terminal, the hardware identifier to the service platform;

determining, by the service platform, whether the hardware identifier is stored in the database; and

triggering, by the service platform, the step of determining, by the service platform, the user level corresponding to the smoking-related data, if the hardware identifier is stored in the database.

In the data communication method, the method further includes:

establishing, by the electronic cigarette, an association relationship between the electronic cigarette and the mobile terminal.

In the data communication method, the establishing, by the electronic cigarette, an association relationship between the electronic cigarette and the mobile terminal includes:

establishing, by the electronic cigarette, the association relationship between the electronic cigarette and the mobile terminal through a Bluetooth connection, a wireless fidelity (WIFI) connection, an infrared connection or a near field communication (NFC) connection, etc.

In the data communication method, before the transmitting, by an electronic cigarette, collected smoking-related data to a mobile terminal bound with the electronic cigarette, the data communication method further includes:

determining, by the electronic cigarette, whether the user is puffing on the electronic cigarette currently;

generating, by the electronic cigarette, a triggering signal if the user is puffing on the electronic cigarette; and

determining, by the electronic cigarette, that the triggering signal is the smoking-related data.

The determining, by the service platform, a user level corresponding to the smoking-related data includes:

determining, by the service platform, times of puffing on the electronic cigarette based on the triggering signal; and

determining, by the service platform, the user level based on the times of puffing on the electronic cigarette.

In the data communication method, before the transmitting, by an electronic cigarette, collected smoking-related data to a mobile terminal bound with the electronic cigarette, the data communication method further includes:

collecting, by the electronic cigarette, durations of respective times of puffing on the electronic cigarette by a user, through a sensor switch arranged inside the electronic cigarette, where the sensor switch is used to correspondingly generate a triggering signal in response to an action of puffing on the electronic cigarette performed by the user, and the electronic cigarette atomizes a cigarette liquid to generate a smoke in response to the triggering signal; or

collecting, by the electronic cigarette, time intervals of smoking of the user through the sensor switch, where the time intervals are intervals between two sequential times of puffing on the electronic cigarette by the user; or

collecting, by the electronic cigarette, time spent in puffing on the electronic cigarette by the user, through the sensor switch; or

collecting, by the electronic cigarette, a frequency that the user puffs on the electronic cigarette, through the sensor switch.

In the data communication method, after the determining, by the service platform, a user level corresponding to the smoking-related data, the data communication method further includes:

transmitting, by the service platform, the determined user level to the mobile terminal; and

determining, by the mobile terminal, a corresponding user permission based on the user level, where the user performs, according to the user permission, a corresponding operation through the mobile terminal.

A data communication system is provided, which includes an electronic cigarette, a mobile terminal and a service platform.

The electronic cigarette is used to transmit collected smoking-related data to the mobile terminal bound with the electronic cigarette.

The mobile terminal is used to transmit the smoking-related data to the service platform.

The service platform is used to determine a user level corresponding to the smoking-related data, determine information corresponding to the user level, and push the information corresponding to the user level to the mobile terminal.

In the data communication system,

the mobile terminal is further used to receive object login information input by a user and push the object login information to the service platform; and

the service platform is further configure to, determine whether the mobile terminal is a registered user, and the service platform is triggered to determine the user level corresponding to the smoking-related data if the mobile terminal is the registered user.

In the data communication system,

the mobile terminal is further used to receive login information input by the user, and transmit the login information to the service platform, where the login information includes a username and a password; and

the service platform is used to, determine whether the username included in the login information is the same as a username stored in the service platform, and determine that the mobile terminal is successfully registered and store the login information into a database if the username included in the login information is not the same as the username stored in the service platform; and the service platform is further used to, determine whether the object login information is the same as the login information stored in the database, and determine that the mobile terminal transmitting the object login information is the registered user if the object login information is the same as the login information stored in the database.

In the data communication system,

the mobile terminal is further used to acquire a hardware identifier of the mobile terminal, and transmit the hardware identifier to the service platform; and

the service platform is further used to determine whether the hardware identifier is stored in a database, and the service platform is triggered to determine the user level corresponding to the smoking-related data if the hardware identifier is stored in the database.

In the data communication system, the mobile terminal is further used to establish an association relationship between the mobile terminal and the electronic cigarette.

In the data communication system,

the electronic cigarette is further used to, determine whether a user is puffing on the electronic cigarette currently, and generate a triggering signal and determine that the triggering signal is the smoking-related data, if the user is puffing on the electronic cigarette currently; and

the service platform is further used to determine times of puffing on the electronic cigarette based on the triggering signal, and determine the user level based on the times of puffing on the electronic cigarette.

In the data communication system,

the electronic cigarette is further used to collect durations of respective times of puffing on the electronic cigarette by a user, through a sensor switch arranged inside the electronic cigarette, where the sensor switch is used to correspondingly generate a triggering signal in response to an action of puffing on the electronic cigarette performed by the user, and the electronic cigarette atomizes a cigarette liquid to generate a smoke in response to the triggering signal; or

the electronic cigarette is further used to collect time intervals of smoking of the user through the sensor switch, where the time intervals are intervals between two sequential times of puffing on the electronic cigarette by the user; or

the electronic cigarette is further used to collect time spent in puffing on the electronic cigarette by the user, through the sensor switch; or

the electronic cigarette is further used to collect a frequency that the user puffs on the electronic cigarette, through the sensor switch.

In the data communication system,

the service platform is further used to transmit the determined user level to the mobile terminal; and

the mobile terminal is further used to determine a corresponding user permission based on the user level, where a user performs, according to the user permission, a corresponding operation through the mobile terminal.

The data communication method and the data communication system are provided in the disclosure. The method includes: transmitting, by an electronic cigarette, collected smoking-related data to a mobile terminal bound with the electronic cigarette; transmitting, by the mobile terminal, the smoking-related data to a service platform; determining, by the service platform, a user level corresponding to the smoking-related data; determining, by the service platform, information corresponding to the user level; and pushing, by the service platform, the information corresponding to the user level to the mobile terminal. The service platform pushes the information corresponding to the smoking-related data to the mobile terminal, and the mobile terminal receives the information, such that the service platform provides a customized information pushing service to the user. Different services may be pushed according to different user levels, and merchants may provide customized services and improve service quality, thereby improving user experience.

### BRIEF DESCRIPTION OF THE DRAWINGS

FIG. 1 is a flow chart of a data communication method provided according to a preferred embodiment of the disclosure;

FIG. 2 is a flow chart a data communication method provided according to an preferred embodiment of the disclosure;

FIG. 3 is a flow chart a data communication method provided according to an preferred embodiment of the disclosure;

FIG. 4 is a schematic structural diagram of a data communication system provided according to three embodiments of the disclosure; and

FIG. 5 is a schematic diagram of a data communication framework provided in the disclosure.

### DETAILED DESCRIPTION OF THE EMBODIMENTS

A data communication method and a data communication system are provided according to embodiments of the disclosure, which may achieve dynamic information interactions between an electronic cigarette and a mobile terminal and between the mobile terminal and a user.

Technical solutions of the embodiments of the present disclosure are illustrated completely and clearly in conjunction with drawings to be used in the embodiments of the disclosure. Apparently, the described embodiments are merely a few rather than all of the embodiments of the present application. All other embodiments obtained by persons of ordinary skill in the art based on the embodiments of the present disclosure without creative efforts shall fall within the protection scope of the present disclosure.

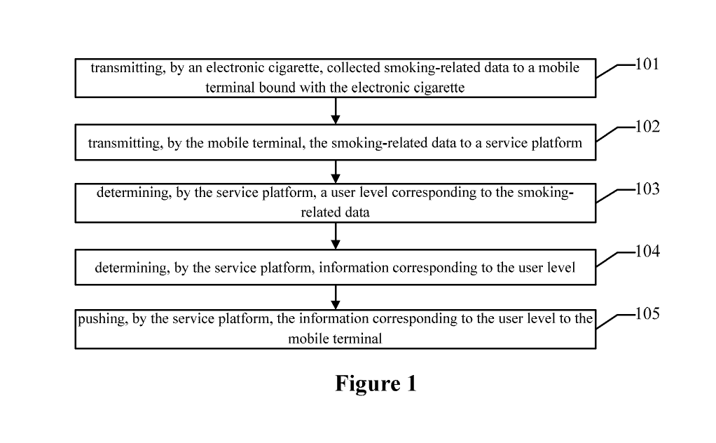

Reference is made to FIG. 1, a data communication method according to an embodiment of the disclosure includes following steps 101-105.

Step 101 includes: transmitting, by an electronic cigarette, collected smoking-related data to a mobile terminal bound with the electronic cigarette.

According to the embodiment, the electronic cigarette is capable of collecting the smoking-related data and transmitting the collected smoking-related data to the mobile terminal bound with the electronic cigarette.

The smoking-related data is not limited according to the embodiment as long as the smoking-related data is data related to the electronic cigarette itself or related data generated during operation of the electronic cigarette.

The mobile terminal according to the embodiment may be a cellphone, a personal computer, a laptop, a tablet computer or terminals of other types, which is not limited herein.

As shown in FIG. 5, in a data communication framework according to the embodiment, the electronic cigarette is bound with the mobile terminal, the mobile terminal is connected to a service platform through a communication network, and one service platform is capable of providing services for multiple electronic cigarettes and multiple mobile terminals.

Step 102 includes: transmitting, by the mobile terminal, the smoking-related data to a service platform.

If the mobile terminal detects that the smoking-related data transmitted by the electronic cigarette is received by the mobile terminal, the mobile terminal transmits the smoking-related data to the service platform.

The terminal may periodically detect whether the smoking-related data transmitted by the electronic cigarette is received by the mobile terminal. The period may be set by a manufacturer before the electronic cigarette leaves factory or may be set according to operation of a user, and a duration of the detection period and setting ways for the detection period are not limited.

Step 103 includes: determining, by the service platform, a user level corresponding to the smoking-related data.

The service platform receives the smoking-related data transmitted by the mobile terminal, analyzes and processes the smoking-related data, so that the service platform may determine the user level corresponding to the smoking-related data based on the smoking-related data.

How the service platform determines the user level based on the smoking-related data is not limited in the embodiment, as long as the service platform is capable of determining the user level based on the smoking-related data.

Step 104 includes: determining, by the service platform, information corresponding to the user level.

The service platform may pre-store an information list including a correspondence among different smoking-related data, user levels and the information.

Content of the information is not limited in the embodiment. For example, the information may be an advertisement; that is, different advertising information may be pushed according to different user levels, thereby achieving customized services. Alternatively, the information may be discount information for shopping; that is, different discount information is pushed according to different user levels, so that merchants may provide more accurate and effective services. Alternatively, the information may be information such as a certificate, a medal, or an invitation to experience a new product.

That is, after the service platform receives the smoking-related data, the user level corresponding to the smoking-related data may be determined according to the information list, and the information corresponding to the user level may be determined according to the information list.

In the embodiment, it is exemplary to determine the information corresponding to the user level according to the information list, and the way for determining the information corresponding to the user level is not limited.

Step 105 includes: pushing, by the service platform, the information corresponding to the user level to the mobile terminal.

The service platform pushes the determined information to the mobile terminal, and the mobile terminal receives the information, such that the service platform provides a customized information pushing service to the user. Different services may be pushed according to different user levels, and merchants may provide customized services and improve service quality, thereby improving user experience.

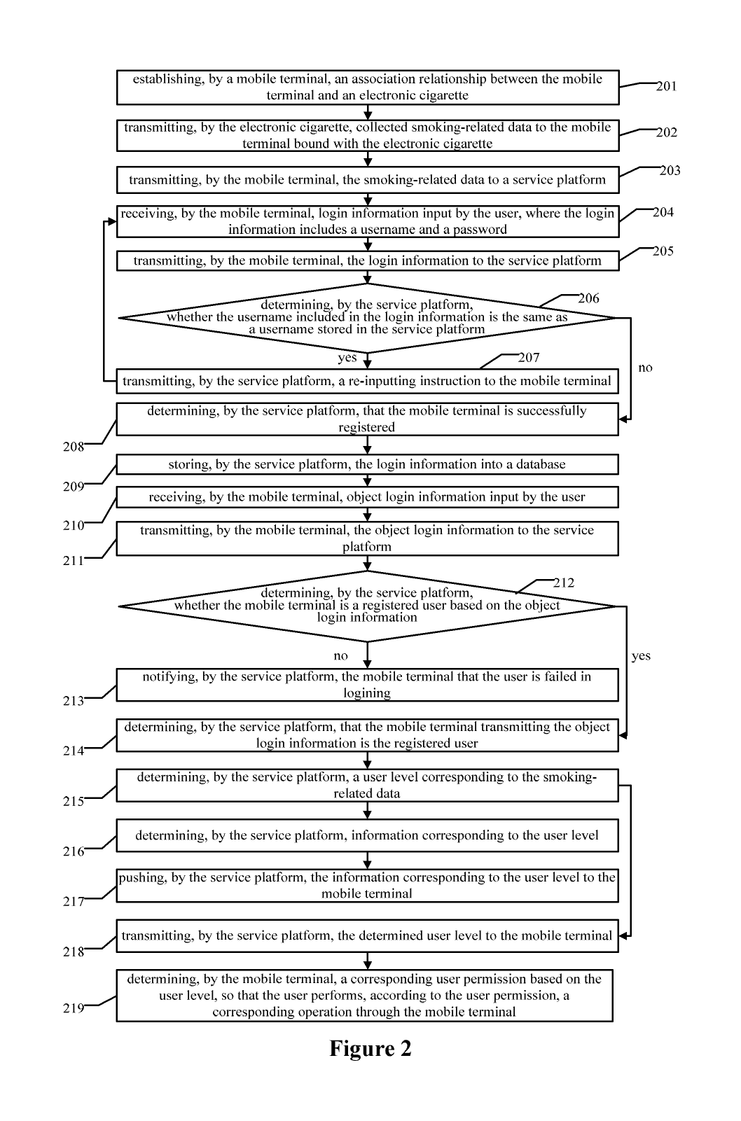

A data communication method according to another embodiment of the disclosure is described in detail in the following. Reference is made to FIG. 2, the data communication method according to the embodiment of the disclosure includes following steps 201-219.

Step 201 includes: establishing, by a mobile terminal, an association relationship between the mobile terminal and an electronic cigarette.

According to the embodiment, a user may bind his electronic cigarette with a mobile terminal. Specifically, the electronic cigarette may establish the association relationship with the mobile terminal through Bluetooth connection, WIFI connection, infrared connection or NFC connection.

For example, the electronic cigarette is provided with a signal generating switch, when the user turns on the signal generation switch of the electronic cigarette, the electronic cigarette transmits a signal. When the signal is searched by the mobile terminal, the user may input a preset personal identification number (pin) code to formally connect the electronic cigarette with the mobile terminal. The electronic cigarette stores an information code trusted by the mobile terminal, and when a signal transmitted by the electronic cigarette is searched by the mobile terminal in a next time, the electronic cigarette is automatically and formally connected to the mobile terminal. The disclosure is not limited to the foregoing example.

Step 202 includes: transmitting, by the electronic cigarette, collected smoking-related data to the mobile terminal bound with the electronic cigarette.

Ways for collecting the smoking-related data by the electronic cigarette according to the embodiment includes, but are not limited to, following ways.

A first collecting way include:

determining, by the electronic cigarette, whether the user is puffing on the electronic cigarette currently,

where a sensor switch used to sense pressure change inside the electronic cigarette is arranged inside the electronic cigarette; if the user smokes, pressure inside the electronic cigarette changes, and the sensor switch correspondingly generates a triggering signal according to the pressure change; i.e., if the sensor switch generates the triggering signal, the electronic cigarette determines that the user is puffing on the electronic cigarette currently, or if the sensor switch does not generate the triggering signal, the electronic cigarette determines that the user is not puffing on the electronic cigarette currently;

generating, by the electronic cigarette, the triggering signal if it is determined that the user is puffing on the electronic cigarette currently,

where the triggering signal is correspondingly generated by the sensor switch according to the pressure change inside the electronic cigarette; and

determining, by the electronic cigarette, that the triggering signal is the smoking-related data.

A second collecting way include:

collecting, by the electronic cigarette, durations of respective times of puffing on the electronic cigarette by the user, through the sensor switch arranged inside the electronic cigarette, where the sensor switch is used to correspondingly generate a triggering signal in response to an action of puffing on the electronic cigarette performed by the user, and the electronic cigarette atomizes a cigarette liquid to generate a smoke in response to the triggering signal; and

determining, by the electronic cigarette, that the durations of respective times of puffing on the electronic cigarette by the user are the smoking-related data.

A third collecting way may include:

collecting, by the electronic cigarette, time intervals of smoking of the user through the sensor switch, where the time intervals are intervals between two sequential times of puffing on the electronic cigarette by the user; and

determining, by the electronic cigarette, that the time intervals are the smoking-related data.

A fourth collecting way may include:

collecting, by the electronic cigarette, time spent in puffing on the electronic cigarette by the user, through the sensor switch; and

determining, by the electronic cigarette, that the time spent in puffing on the electronic cigarette by the user is the smoking-related data.

A fifth collecting way may include:

collecting, by the electronic cigarette, a frequency that the user puffs on the electronic cigarette, through the sensor switch; and

determining, by the electronic cigarette, that the frequency that the user puffs on the electronic cigarette is the smoking-related data.

The smoking-related data is not limited to the above exemplary descriptions according to the embodiment. For example, the smoking-related data may be the number of flavors of the cigarette liquid stored in the electronic cigarette.

Step 203 includes: transmitting, by the mobile terminal, the smoking-related data to a service platform.

Detailed processes of step 202 and step 203 according to the embodiment can be understood with reference to step 101 and step 102 shown in FIG. 1, and are not described in the embodiment.

Step 204 includes: receiving, by the mobile terminal, login information input by the user, where the login information includes a username and a password.

That is, the user needs to register through the mobile terminal first, and the service platform only provides customized services for a successfully registered user.

Step 205 includes: transmitting, by the mobile terminal, the login information to the service platform.

The mobile terminal transmits the received login information to the service platform.

Step 206 includes: determining, by the service platform, whether the username included in the login information is the same as a username stored in the service platform, if the username included in the login information is the same as the username stored in the service platform, step 207 is to be executed, or if the username included in the login information is not the same as the username stored in the service platform, step 208 is to be executed.

That is, the service platform detects whether the username input by the user is already registered by other users, if the username stored in the service platform is not the same as the username input by the user through the mobile terminal, it is indicated that the username input by the user and received by the mobile terminal is not registered, and the username is available.

Step 207 includes: transmitting, by the service platform, a re-inputting instruction to the mobile terminal.

That is, if the username input by the user and received by the mobile terminal is already registered, the service platform generates the re-inputting instruction.

The service platform transmits the re-inputting instruction to the mobile terminal, the mobile terminal generates notification information in response to the re-inputting instruction, and the user may re-input a username in response to the notification information.

After step 207 is finished, the data communication method returns to step 204, i.e., the mobile terminal receives again the login information input by the user, until a registration is successful.

Step 208 includes: determining, by the service platform, that the mobile terminal is successfully registered.

Step 209 includes: storing, by the service platform, the login information into a database.

The service platform stores the login information of the successfully registered mobile terminal into the database to facilitate subsequent operations.

Step 204 to step 209 according to the embodiment are steps with which the mobile terminal is registered at the service platform, and a precedence relationship between step 202 to step 203 and step 204 to step 209 illustrated according to the embodiment is exemplary and the precedence relationship is not limited thereto. For example, the mobile terminal may be registered first (step 204 to step 209) and then collect and transmit the smoking-related data (step 202 to step 203).

The step 204 to step 209 are optional steps. If the user is already successfully registered, the user only needs to login without repeating the registration, i.e., if the user is already successfully registered, there is no need to perform step 204 to step 209.

Step 210 includes: receiving, by the mobile terminal, object login information input by the user.

If the user is already registered at the service platform, the user only needs to input the object login information when using the electronic cigarette and the mobile terminal.

The object login information according to the embodiment is the username and the password which are input during the registration.

Step 211 includes: transmitting, by the mobile terminal, the object login information to the service platform.

Step 212 includes: determining, by the service platform, whether the mobile terminal is a registered user based on the object login information, if the mobile terminal is the registered user, step 213 is to be executed, or if the mobile terminal is not the registered user, step 214 is to be executed.

According to the embodiment, a specific way for determining, by the service platform, whether the mobile terminal is the registered user is described as follows:

the service platform determines whether the object login information is the same as the login information stored in the database;

if the object login information is the same as the login information stored in the database, it is indicated that the user is the registered user; or

if the object login information is not the same as the login information stored in the database, it is indicated that the user is not the registered user.

Step 213 includes: notifying, by the service platform, the mobile terminal that the user is failed in logining.

That is, if the service platform determines that the user is not the registered user, the service platform notifies the mobile terminal that the user is not the registered user, i.e., the mobile terminal is notified that the user is failed in logining.

Step 214 includes: determining, by the service platform, that the mobile terminal transmitting the object login information is the registered user, i.e.,

determining, by the service platform, that the user of the mobile terminal logins successfully.

Step 215 includes: determining, by the service platform, a user level corresponding to the smoking-related data,

i.e., determining, by the service platform, user levels correspondingly based on different smoking-related data input by the mobile terminal.

For example, if the service platform determines that the smoking-related data forwarded by the mobile terminal is the triggering signal transmitted by the electronic cigarette, the service platform may determine times of puffing on the electronic cigarette based on the triggering signal.

Specifically, the service platform determines the times of puffing on the electronic cigarette as follows: the service platform records total times of transmitting the triggering signal by a successfully logged-in mobile terminal, and determines the total times as the times of puffing on the electronic cigarette.

For example, when the mobile terminal logins for a first time, the electronic cigarette is puffed on twice; when the mobile terminal logins for a second time, the electronic cigarette is puffed on for 3 times; and when the mobile terminal logins for a third time, the service platform may determine that the times of puffing on the electronic cigarette is 5 which is a sum of 2 and 3, according to the recorded data.

The service platform determines the user level according to the times of puffing on the electronic cigarette. For example, if the times of puffing on the electronic cigarette is in a range of 0-10, the user level is a first user level, if the times of puffing on the electronic cigarette is in a range of 10-20, the user level is a second level, while a specific standard for grading is not described in the embodiment.

If the service platform determines that the smoking-related data forwarded by the mobile terminal is durations of respective times of puffing on the electronic cigarette by the user, the service platform may determine the user level according to different durations of respective times of puffing on the electronic cigarette by the user.

If the service platform determines that the smoking-related data forwarded by the mobile terminal is time intervals of smoking of the user, the service platform may determine the user level according to different time intervals.

If the service platform determines that the smoking-related data forwarded by the mobile terminal is time spent in puffing on the electronic cigarette by the user, the service platform may determine the user level according to different time spent in puffing on the electronic cigarette by the user.

If the service platform determines that the smoking-related data forwarded by the mobile terminal is a frequency that the user puffs on the electronic cigarette, the service platform may determine the user level according to different frequencies that the user puffs on the electronic cigarette.

Step 216 includes: determining, by the service platform, information corresponding to the user level.

Step 217 includes: pushing, by the service platform, the information corresponding to the user level to the mobile terminal.

Therefore, it is implemented that different information is pushed to mobile terminals with different user levels according to the embodiment, thereby achieving customized services for users.

For example, different product recommendation information and different discount information, etc, are pushed to the mobile terminal with different user levels.

After step 215, the data communication method may further include following steps 218 and 219.

Step 218 includes: transmitting, by the service platform, the determined user level to the mobile terminal.

Step 219 includes: determining, by the mobile terminal, a corresponding user permission based on the user level, so that the user performs, according to the user permission, a corresponding operation through the mobile terminal.

The service platform grants different permissions to users of different user levels. For example, the service platform may grant permissions of posting, teaming up and speaking to the mobile terminals of different user levels.

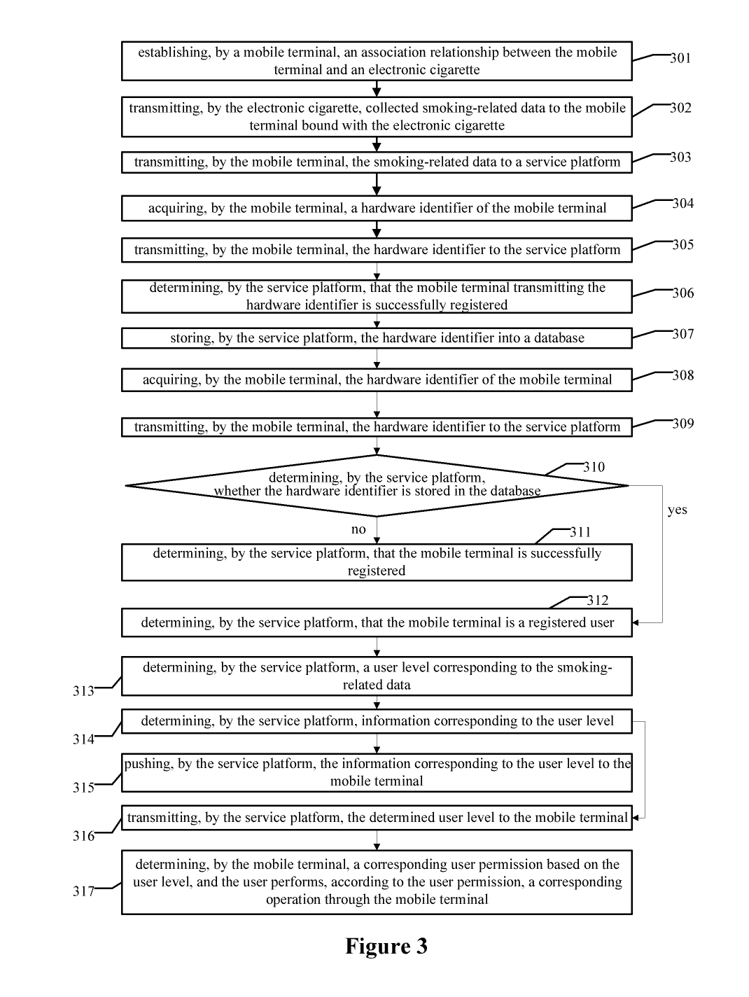

A data communication method according to another embodiment is described in detail in conjunction with FIG. 3.

Step 301 includes: establishing, by a mobile terminal, an association relationship between the mobile terminal and an electronic cigarette.

Step 302 includes: transmitting, by the electronic cigarette, collected smoking-related data to the mobile terminal bound with the electronic cigarette.

Step 303 includes: transmitting, by the mobile terminal, the smoking-related data to a service platform.

Detailed processes of step 301 and step 303 according to the embodiment can be understood with reference to step 201 and step 203 shown in FIG. 2, and are not described in the embodiment.

Step 304 includes: acquiring, by the mobile terminal, a hardware identifier of the mobile terminal.

How the mobile terminal acquires the hardware identifier of the mobile terminal is conventional technology, and accordingly, is not described in the embodiment.

Step 305 includes: transmitting, by the mobile terminal, the hardware identifier to the service platform.

Step 306 includes: determining, by the service platform, that the mobile terminal transmitting the hardware identifier is successfully registered.

Step 307 includes: storing, by the service platform, the hardware identifier into a database.

The service platform stores the hardware identifier of the successfully registered mobile terminal into the database to facilitate subsequent operations.

Step 304 to step 307 according to the embodiment are steps with which the mobile terminal is registered at the service platform, and a precedence relationship between step 301 to step 303 and step 304 to step 307 illustrated according to the embodiment is exemplary and the precedence relationship is not limited thereto. For example, the mobile terminal may be registered first (step 304 to step 307) and then collects and transmits the smoking-related data (step 301 to step 303).

The step 304 to step 307 are optional steps. If the user is successfully registered, the user only needs to login without repeating the registration, i.e., if the user is successfully registered, there is no need to perform step 304 to step 307.

The registered mobile terminal logins to the service platform as follows.

Step 308 includes: acquiring, by the mobile terminal, the hardware identifier of the mobile terminal,

i.e., when the mobile terminal logins to the service platform, the mobile terminal automatically acquires the hardware identifier of the mobile terminal without inputting the login information by the user.

Step 309 includes: transmitting, by the mobile terminal, the hardware identifier to the service platform.

The mobile terminal transmits the hardware identifier acquired during the login process to the service platform.

Step 310 includes: determining, by the service platform, whether the hardware identifier is stored in the database, if the hardware identifier is not stored in the database, step 311 is to be executed, or if the hardware identifier is stored in the database, step 312 is to be executed.

If the hardware identifier is stored in the database, it is indicated that the mobile terminal is already successfully registered, and the mobile terminal successfully logins.

If the hardware identifier is not stored in the database, it is indicated that the mobile terminal is not registered, and the service platform records the hardware identifier of the mobile terminal so that the mobile terminal is successfully registered.

Step 311 includes: determining, by the service platform, that the mobile terminal is successfully registered;

i.e., since the mobile terminal is not registered, the mobile terminal transmitting the hardware identifier is to be registered to facilitate subsequent operations.

Step 312 includes: determining, by the service platform, that the mobile terminal is a registered user.

Step 313 includes: determining, by the service platform, a user level corresponding to the smoking-related data.

Step 314 includes: determining, by the service platform, information corresponding to the user level.

Step 315 includes: pushing, by the service platform, the information corresponding to the user level to the mobile terminal.

After step 314, the data communication method may further include following steps 316 and 317.

Step 316 includes: transmitting, by the service platform, the determined user level to the mobile terminal.

Step 317 includes: determining, by the mobile terminal, a corresponding user permission based on the user level, and the user performs, according to the user permission, a corresponding operation through the mobile terminal.

Step 313 to step 317 according to the embodiment are the same as step 215 to step 219 as shown in FIG. 2 and are not described in the embodiment.

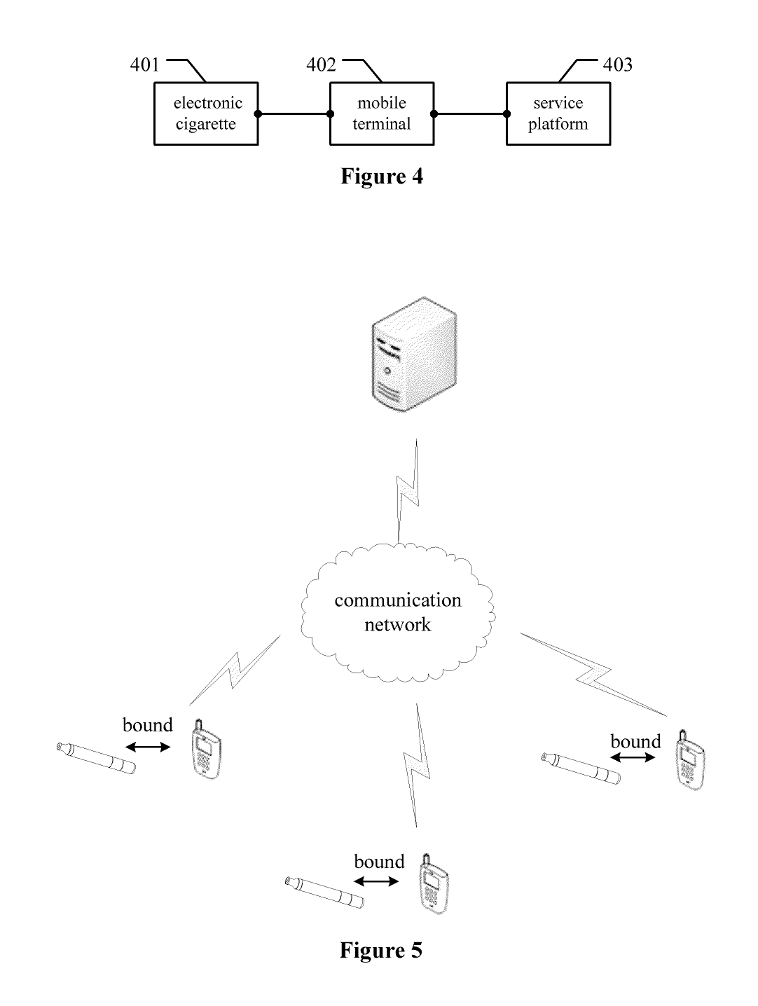

The data communication methods according to the disclosure are described in the foregoing. A data communication system is described in detail hereinafter in conjunction with FIG. 4.

The data communication system includes: an electronic cigarette 401, a mobile terminal 402 and a service platform 403.

The electronic cigarette is used to transmit collected smoking-related data to the mobile terminal bound with the electronic cigarette.

According to the embodiment, the electronic cigarette is capable of collecting smoking-related data, and transmitting the collected smoking-related data to the mobile terminal bound with the electronic cigarette.

The smoking-related data is not limited according to the embodiment as long as the smoking-related data is data related to the electronic cigarette itself or related data generated during operation of the electronic cigarette.

The mobile terminal according to the embodiment may be a cellphone, a personal computer, a laptop, a tablet computer or terminals of other types, which is not limited herein.

The mobile terminal is used to transmit the smoking-related data to the service platform.

If the mobile terminal detects that the smoking-related data transmitted by the electronic cigarette is received by the mobile terminal, the mobile terminal transmits the smoking-related data to the service platform.

The terminal may periodically detect whether the smoking-related data transmitted by the electronic cigarette is received by the mobile terminal. The period may be set by a manufacturer before the electronic cigarette leaves factory or may be set according to operation of a user, and a duration of the detection period and setting ways for the detection period are not limited.

The service platform is used to determine a user level corresponding to the smoking-related data;

The service platform receives the smoking-related data transmitted by the mobile terminal, analyzes and processes the smoking-related data, so that the service platform may determine the user level corresponding to the smoking-related data based on the smoking-related data.

How the service platform determines the user level based on the smoking-related data is not limited in the embodiment, as long as the service platform is capable of determining the user level based on the smoking-related data.

The service platform is used to determine information corresponding to the user level.

The service platform may pre-store an information list including a correspondence among different smoking-related data, user levels and the information.

Content of the information is not limited in the embodiment. For example, the information may be an advertisement; that is, different advertising information may be pushed according to different user levels, thereby achieving customized services. Alternatively, the information may be discount information for shopping; that is, different discount information is pushed according to different user levels, so that merchants may provide more accurate and effective services. Alternatively, the information may be information such as a certificate, a medal, or an invitation to experience a new product.

That is, after the service platform receives the smoking-related data, the user level corresponding to the smoking-related data may be determined according to the information list, and the information corresponding to the user level may be determined according to the information list.

In the embodiment, it is exemplary to determine the information corresponding to the user level according to the information list, and the way for determining the information corresponding to the user level is not limited.

The service platform is used to push the information corresponding to the user level to the mobile terminal.

The service platform pushes the determined information to the mobile terminal, and the mobile terminal receives the information, such that the service platform provides a customized information pushing service to the user. Different services may be pushed according to different user levels, and merchants may provide customized services and improve service quality, thereby improving user experience.

Reference is still made to FIG. 4, the data communication system is further described in the following.

The mobile terminal is used to establish an association relationship between the mobile terminal and the electronic cigarette.

According to the embodiment, a user may bind his electronic cigarette with a mobile terminal. Specifically, the electronic cigarette may establish the association relationship with the mobile terminal through Bluetooth connection, WIFI connection, infrared connection or NFC connection.

For example, the electronic cigarette is provided with a signal generating switch, when the user turns on the signal generation switch of the electronic cigarette, the electronic cigarette transmits a signal. When the signal is searched by the mobile terminal, the user may input a preset personal identification number (pin) code to formally connect the electronic cigarette with the mobile terminal. The electronic cigarette stores an information code trusted by the mobile terminal, and when a signal transmitted by the electronic cigarette is searched by the mobile terminal in a next time, the electronic cigarette is automatically and formally connected to the mobile terminal. The disclosure is not limited to the foregoing example.

The electronic cigarette is used to transmit collected smoking-related data to the mobile terminal bound with the electronic cigarette.

Ways for collecting the smoking-related data by the electronic cigarette according to the embodiment includes, but are not limited to, following ways.

A first collecting way include:

determining, by the electronic cigarette, whether the user is puffing on the electronic cigarette currently,

where a sensor switch used to sense pressure change inside the electronic cigarette is arranged inside the electronic cigarette; if the user smokes, pressure inside the electronic cigarette changes, and the sensor switch correspondingly generates a triggering signal according to the pressure change; i.e., if the sensor switch generates the triggering signal, the electronic cigarette determines that the user is puffing on the electronic cigarette currently, or if the sensor switch does not generate the triggering signal, the electronic cigarette determines that the user is not puffing on the electronic cigarette currently;

generating, by the electronic cigarette, the triggering signal if it is determined that the user is puffing on the electronic cigarette currently,

where the triggering signal is correspondingly generated by the sensor switch according to the pressure change inside the electronic cigarette; and

determining, by the electronic cigarette, that the triggering signal is the smoking-related data.

A second collecting way may include:

collecting, by the electronic cigarette, durations of respective times of puffing on the electronic cigarette by the user, through the sensor switch arranged inside the electronic cigarette, where the sensor switch is used to correspondingly generate a triggering signal in response to an action of puffing on the electronic cigarette performed by the user, and the electronic cigarette atomizes electronic cigarette liquid to generate a smoke in response to the triggering signal; and

determining, by the electronic cigarette, that the durations of respective times of puffing on the electronic cigarette by the user are the smoking-related data.

A third collecting way may include:

collecting, by the electronic cigarette, time intervals of smoking of the user through the sensor switch, where the time intervals are intervals between two sequential times of puffing on the electronic cigarette by the user; and

determining, by the electronic cigarette, that the time intervals are the smoking-related data.

A fourth collecting way may include:

collecting, by the electronic cigarette, time spent in puffing on the electronic cigarette by the user, through the sensor switch; and

determining, by the electronic cigarette, that the time spent in puffing on the electronic cigarette by the user is the smoking-related data.

A fifth collecting way may include:

collecting, by the electronic cigarette, a frequency that the user puffs on the electronic cigarette, through the sensor switch; and

determining, by the electronic cigarette, that the frequency that the user puffs on the electronic cigarette is the smoking-related data.

The smoking-related data is not limited to the above exemplary descriptions according to the embodiment. For example, the smoking-related data may be the number of flavors of the cigarette liquid stored in the electronic cigarette.

The mobile terminal is used to transmit the smoking-related data to the service platform.

The mobile terminal is used to receive login information input by the user, where the login information includes a username and a password.

That is, the user needs to register through the mobile terminal first, and the service platform only provides customized services for a successfully registered user.

The mobile terminal is used to transmit the login information to the service platform.

The mobile terminal transmits the received login information to the service platform.

The service platform is used to determine whether the username included in the login information is the same as a username stored in the service platform.

That is, the service platform detects whether the username input by the user is already registered by other users, if the username stored in the service platform is not the same as the username input by the user through the mobile terminal, it is indicated that the username input by the user and received by the mobile terminal is not registered, and the username is available.

If the service platform determines that the username included in the login information is the same as the username stored in the service platform, the service platform is used to transmit a re-inputting instruction to the mobile terminal.

I.e., if the username input by the user and received by the mobile terminal is registered, the service platform generates the re-inputting instruction;

the service platform transmits the re-inputting instruction to the mobile terminal, the mobile terminal generates notification information in response to the re-inputting instruction, and the user may re-input a username in response to the notification information;

and the mobile terminal receives again the login information input by the user until a registration is successful.

If the service platform determines that the username included in the login information is not the same as the username stored in the service platform, the service platform is used to determine that the mobile terminal is successfully registered.

The service platform is used to store the login information into a database.

The service platform stores the login information for the successfully registered mobile terminal into the database to facilitate subsequent operations.

The mobile terminal is used to receive object login information input by the user,

That is, if the user is already registered at the service platform, the user only needs to input the object login information when using the electronic cigarette and the mobile terminal.

The object login information according to the embodiment is the username and the password which are input during the registration.

The mobile terminal is used to transmit the object login information to the service platform.

The service platform is used to determine whether the mobile terminal is a registered user based on the object login information.

According to the embodiment, a specific way for determining, by the service platform, whether the mobile terminal is the registered user is described as follows:

the service platform determines whether the object login information is the same as the login information stored in the database;

if the object login information is the same as the login information stored in the database, it is indicated that the user is the registered user; or

if the object login information is not the same as the login information stored in the database, it is indicated that the user is not the registered user.

If the service platform determines that the mobile terminal is not the registered user based on the object login information, the service platform notifies the mobile terminal that the user is failed in logining.

That is, if the service platform determines that the user is not the registered user, the service platform notifies the mobile terminal that the user is not the registered user, i.e., the mobile terminal is notified that the user is failed in logining.

If the service platform determines that the mobile terminal is the registered user based on the object login information, the mobile terminal is configured to determine that the mobile terminal transmitting the object login information is the registered user,

i.e., the service platform determines that the user of the mobile terminal logins successfully.

The service platform is used to determine a user level corresponding to the smoking-related data,

i.e., the service platform determines user levels correspondingly based on different smoking-related data input by the mobile terminal.

For example, if the service platform determines that the smoking-related data forwarded by the mobile terminal is the triggering signal transmitted by the electronic cigarette, the service platform may determine times of puffing on the electronic cigarette based on the triggering signal.

Specifically, the service platform determines the times of puffing on the electronic cigarette as follows: the service platform records total times of transmitting the triggering signal by a successfully logged-in mobile terminal, and determines the total times as the times of puffing on the electronic cigarette.

For example, when the mobile terminal logins for a first time, the electronic cigarette is puffed on twice; when the mobile terminal logins for a second time, the electronic cigarette is puffed on for 3 times; and when the mobile terminal logins for a third time, the service platform may determine that the times of puffing on the electronic cigarette is 5 which is a sum of 2 and 3, according to the recorded data.

The service platform determines the user level according to the times of puffing on the electronic cigarette. For example, if the times of puffing on the electronic cigarette is in a range of 0-10, the user level is a first user level, if the times of puffing on the electronic cigarette is in a range of 10-20, the user level is a second level, while a specific standard for grading is not described in the embodiment.

If the service platform determines that the smoking-related data forwarded by the mobile terminal is durations of respective times of puffing on the electronic cigarette by the user, the service platform may determine the user level according to different durations of respective times of puffing on the electronic cigarette by the user.

If the service platform determines that the smoking-related data forwarded by the mobile terminal is time intervals of smoking of the user, the service platform may determine the user level according to different time intervals.

If the service platform determines that the smoking-related data forwarded by the mobile terminal is time spent in puffing on the electronic cigarette by the user, the service platform may determine the user level according to different time spent in puffing on the electronic cigarette by the user.

If the service platform determines that the smoking-related data forwarded by the mobile terminal is a frequency that the user puffs on the electronic cigarette, the service platform may determine the user level according to different frequencies that the user puffs on the electronic cigarette.

The service platform is used to determine information corresponding to the user level.

The service platform is used to push the information corresponding to the user level to the mobile terminal.

Therefore, it is implemented that different information is pushed to mobile terminals with different user levels according to the embodiment, thereby achieving customized services for users.

For example, different product recommendation information and different discount information, etc, are pushed to the mobile terminal with different user levels.

The service platform is used to transmit the determined user level to the mobile terminal.

The mobile terminal is used to determine a corresponding user permission based on the user level, so that the user performs, according to the user permission, a corresponding operation through the mobile terminal.

The service platform grants different permissions to users of different user levels. For example, the service platform may grant permissions of posting, teaming up and speaking to the mobile terminals of different user levels.

Reference is still made to FIG. 4, the data communication system is further described.

The mobile terminal is used to establish an association relationship between the mobile terminal and the electronic cigarette.

The electronic cigarette is used to transmit collected smoking-related data to the mobile terminal bound with the electronic cigarette.

The mobile terminal is used to transmit the smoking-related data to the service platform.

The mobile terminal is used to acquire a hardware identifier of the mobile terminal.

How the mobile terminal acquires the hardware identifier of the mobile terminal is conventional technology, and accordingly, is not described in the embodiment.

The mobile terminal is used to transmit the hardware identifier to the service platform.

The service platform is used to determine that the mobile terminal transmitting the hardware identifier is registered successfully.

The service platform is used to store the hardware identifier into a database.

The service platform stores the hardware identifier of the successful registered mobile terminal into the database to facilitate subsequent operations.

The mobile terminal is used to acquire the hardware identifier of the mobile terminal,

i.e., when the mobile terminal logins to the service platform, the mobile terminal automatically acquires the hardware identifier of the mobile terminal without inputting the login information by the user.

The mobile terminal is used to transmit the hardware identifier to the service platform.

The mobile terminal transmits the hardware identifier acquired during the login process to the service platform.

The service platform determines whether the hardware identifier is stored in the database.

If the hardware identifier is stored in the database, it is indicated that the mobile terminal is already successfully registered, and the mobile terminal successfully logins.

If the hardware identifier is not stored in the database, it is indicated that the mobile terminal is not registered, and the service platform records the hardware identifier of the mobile terminal so that the mobile terminal is successfully registered.

If the service platform determines that the hardware identifier is stored in the database, the service platform is used to determine that the mobile terminal is successfully registered.

The service platform is used to determine that the mobile terminal is a registered user.

The service platform is used to determine a user level corresponding to the smoking-related data;

The service platform is used to determine information corresponding to the user level.

The service platform is used to push the information corresponding to the user level to the mobile terminal.

The service platform is used to transmit the determined user level to the mobile terminal.

The mobile terminal is used to determine a corresponding user permission based on the user level, so that the user performs, according to the user permission, a corresponding operation through the mobile terminal.

The person skilled in the art may clearly understand that, to describe conveniently and simply, specific operating processes of the foregoing described system, device and unit may be understood with reference to corresponding processes in the method embodiments of the disclosure, and are not described herein.

The above embodiments are only used to illustrate the technical solutions and are not meant to limit the technical solutions. Though the disclosure is described in detail with reference to the foregoing embodiments, it should be understood by person skilled in the art that modifications can be made to the technical solutions according to the embodiments, or equivalent replacements may be made to part of the technical features, and with these modifications or replacements, the basic idea for corresponding technical solutions does not depart from the spirit and the scope of the technical solutions according to the embodiments of the disclosure.

1. A data communication method, comprising:
transmitting, by an electronic cigarette, collected smoking-related data to a mobile terminal bound with the electronic cigarette;
transmitting, by the mobile terminal, the smoking-related data to a service platform;
determining, by the service platform, a user level corresponding to the smoking-related data;
determining, by the service platform, information corresponding to the user level; and
pushing, by the service platform, the information corresponding to the user level to the mobile terminal.

2. The data communication method according to claim 1, wherein before the determining, by the service platform, a user level corresponding to the smoking-related data, the data communication method further comprises:
receiving, by the mobile terminal, object login information input by a user;
transmitting, by the mobile terminal, the object login information to the service platform;
determining, by the service platform, whether the mobile terminal is a registered user based on the object login information; and
triggering, by the service platform, the step of determining, by the service platform, the user level corresponding to the smoking-related data, if the mobile terminal is the registered user.

3. The data communication method according to claim 2, wherein before the receiving, by the mobile terminal, object login information input by a user, the data communication method further comprises:
receiving, by the mobile terminal, login information input by the user, wherein the login information comprises a username and a password;
transmitting, by the mobile terminal, the login information to the service platform;
determining, by the service platform, whether the username comprised in the login information is the same as a username stored in the service platform;
determining, by the service platform, that the mobile terminal is successfully registered if the username comprised in the login information is not the same as the username stored in the service platform; and
storing, by the service platform, the login information into a database; and
wherein the determining, by the service platform, whether the mobile terminal is a registered user based on the object login information comprises:
determining, by the service platform, whether the object login information is the same as the login information stored in the database; and
determining, by the service platform, that the mobile terminal transmitting the object login information is the registered user if the object login information is the same as the login information stored in the database.

4. The data communication method according to claim 1, wherein before the determining, by the service platform, a user level corresponding to the smoking-related data, the data communication method further comprises:
acquiring, by the mobile terminal, a hardware identifier of the mobile terminal;
transmitting, by the mobile terminal, the hardware identifier to the service platform;
determining, by the service platform, whether the hardware identifier is stored in a database; and
triggering, by the service platform, the step of determining, by the service platform, the user level corresponding to the smoking-related data, if the hardware identifier is stored in the database.

5. The data communication method according to claim 1, further comprising:
establishing, by the electronic cigarette, an association relationship between the electronic cigarette and the mobile terminal.

6. The data communication method according to claim 5, wherein the establishing, by the electronic cigarette, an association relationship between the electronic cigarette and the mobile terminal comprises:
establishing, by the electronic cigarette, the association relationship between the electronic cigarette and the mobile terminal through a Bluetooth connection, a wireless fidelity connection, an infrared connection or a near field communication connection.

7. The data communication method according to claim 1, wherein before the transmitting, by an electronic cigarette, collected smoking-related data to a mobile terminal bound with the electronic cigarette, the data communication method further comprises:
determining, by the electronic cigarette, whether a user is puffing on the electronic cigarette currently;
generating, by the electronic cigarette, a triggering signal if the user is puffing on the electronic cigarette; and
determining, by the electronic cigarette, that the triggering signal is the smoking-related data; and
wherein the determining, by the service platform, a user level corresponding to the smoking-related data comprises:
determining, by the service platform, times of puffing on the electronic cigarette based on the triggering signal; and
determining, by the service platform, the user level based on the times of puffing on the electronic cigarette.

8. The data communication method according to claim 1, wherein before the transmitting, by an electronic cigarette, collected smoking-related data to a mobile terminal bound with the electronic cigarette, the data communication method further comprises:
collecting, by the electronic cigarette, durations of respective times of puffing on the electronic cigarette by a user, through a sensor switch arranged inside the electronic cigarette, wherein the sensor switch is configured to correspondingly generate a triggering signal in response to an action of puffing on the electronic cigarette performed by the user, and the electronic cigarette atomizes a cigarette liquid to generate a smoke in response to the triggering signal; or
collecting, by the electronic cigarette, time intervals of smoking of the user through the sensor switch, wherein the time intervals are intervals between two sequential times of puffing on the electronic cigarette by the user; or
collecting, by the electronic cigarette, time spent in puffing on the electronic cigarette by the user, through the sensor switch; or
collecting, by the electronic cigarette, a frequency that the user puffs on the electronic cigarette, through the sensor switch.

9. The data communication method according to claim 1, wherein after the determining, by the service platform, a user level corresponding to the smoking-related data, the data communication method further comprises:
transmitting, by the service platform, the determined user level to the mobile terminal; and
determining, by the mobile terminal, a corresponding user permission based on the user level, wherein a user performs, according to the user permission, a corresponding operation through the mobile terminal.

10. A data communication system, comprising an electronic cigarette, a mobile terminal and a service platform; wherein
the electronic cigarette is configured to transmit collected smoking-related data to the mobile terminal bound with the electronic cigarette;
the mobile terminal is configured to transmit the smoking-related data to the service platform; and
the service platform is configured to determine a user level corresponding to the smoking-related data, determine information corresponding to the user level, and push the information corresponding to the user level to the mobile terminal.

11. The data communication system according to claim 10, wherein
the mobile terminal is further configured to receive object login information input by a user and push the object login information to the service platform; and
the service platform is further configure to, determine whether the mobile terminal is a registered user, and the service platform is triggered to determine the user level corresponding to the smoking-related data if the mobile terminal is the registered user.

12. The data communication system according to claim 11, wherein
the mobile terminal is further configured to receive login information input by the user, and transmit the login information to the service platform, wherein the login information comprises a username and a password; and
the service platform is configured to, determine whether the username comprised in the login information is the same as a username stored in the service platform, and determine that the mobile terminal is successfully registered and store the login information into a database if the username comprised in the login information is not the same as the username stored in the service platform; and the service platform is further configured to, determine whether the object login information is the same as the login information stored in the database, and determine that the mobile terminal transmitting the object login information is the registered user if the object login information is the same as the login information stored in the database.

13. The data communication system according to claim 10, wherein
the mobile terminal is further configured to acquire a hardware identifier of the mobile terminal, and transmit the hardware identifier to the service platform; and
the service platform is further configured to determine whether the hardware identifier is stored in a database, and the service platform is triggered to determine the user level corresponding to the smoking-related data if the hardware identifier is stored in the database.

14. The data communication system according to claim 10, wherein the mobile terminal is further configured to establish an association relationship between the mobile terminal and the electronic cigarette.

15. The data communication system according to claim 10, wherein
the electronic cigarette is further configured to, determine whether a user is puffing on the electronic cigarette currently, and generate a triggering signal and determine that the triggering signal is the smoking-related data, if the user is puffing on the electronic cigarette currently; and
the service platform is further configured to determine times of puffing on the electronic cigarette based on the triggering signal, and determine the user level based on the times of puffing on the electronic cigarette.

16. The data communication system according to claim 10, wherein
the electronic cigarette is further configured to collect durations of respective times of puffing on the electronic cigarette by a user, through a sensor switch arranged inside the electronic cigarette, wherein the sensor switch is configured to correspondingly generate a triggering signal in response to an action of puffing on the electronic cigarette performed by the user, and the electronic cigarette atomizes a cigarette liquid to generate a smoke in response to the triggering signal; or
the electronic cigarette is further configured to collect time intervals of smoking of the user through the sensor switch, wherein the time intervals are intervals between two sequential times of puffing on the electronic cigarette by the user; or
the electronic cigarette is further configured to collect time spent in puffing on the electronic cigarette by the user, through the sensor switch; or
the electronic cigarette is further configured to collect a frequency that the user puffs on the electronic cigarette, through the sensor switch.

17. The data communication system according to claim 10, wherein
the service platform is further configured to transmit the determined user level to the mobile terminal; and
the mobile terminal is further configured to determine a corresponding user permission based on the user level, wherein a user performs, according to the user permission, a corresponding operation through the mobile terminal.
